(19) United States
(12) Patent Application Publication
(10) Pub. No.: US 2020/0101490 A1
(43) Pub. Date: Apr. 2, 2020

(54) FILM FORMING APPARATUS AND TEMPERATURE CONTROL METHOD

(71) Applicant: TOKYO ELECTRON LIMITED, Tokyo (JP)

(72) Inventors: Syuji NOZAWA, Nirasaki City (JP); Tatsuya YAMAGUCHI, Nirasaki City (JP)

(21) Appl. No.: 16/582,031

(22) Filed: Sep. 25, 2019

(30) Foreign Application Priority Data
Sep. 27, 2018 (JP) 2018181955

(51) Int. Cl. B05D 1/00

(52) U.S. Cl. CPC B05D 1/60

(57) ABSTRACT

There is provided a film forming apparatus for forming a polymer film on a target substrate by a deposition polymerization, including: a stage provided inside a processing container in which the target substrate is accommodated, the target substrate being placed on the stage; a stage heater provided inside the stage and configured to heat the target substrate placed on the stage; a ceiling plate heater provided in a ceiling plate of the processing container to face the stage; and a controller configured to control a temperature of the target substrate in a first temperature unit by controlling a temperature of the stage heater on the first temperature unit, and to control the temperature of the target substrate on a temperature unit finer than the first temperature unit by a radiant heat radiated through the ceiling plate by controlling a temperature of the ceiling plate heater on a second temperature unit.

### CROSS-REFERENCE TO RELATED APPLICATION

This application is based upon and claims the benefit of priority from Japanese Patent Application No. 2018-181955, filed on Sep. 27, 2018, the entire contents of which are incorporated herein by reference.

### TECHNICAL FIELD

Various aspects and embodiments of the present disclosure relate to a film forming apparatus and a temperature control method.

### BACKGROUND

There is known a technique for forming an organic film of a polymer on a target substrate by supplying a gas containing the two types of monomers into a processing container in which the target substrate is accommodated, and causing a polymerization reaction of the two types of monomers. For example, there is known a technique for forming a polymer film on a target substrate by a vacuum deposition polymerization reaction of an aromatic alkyl, alicyclic, or aliphatic diisocyanate monomer, and an aromatic alkyl, alicyclic, or aliphatic diamine monomer (see, for example, Patent Document 1).

### PRIOR ART DOCUMENT

### Patent Documents

Patent Document 1: International Publication No. WO 2008/129925

### SUMMARY

According to an embodiment of the present disclosure, there is provided a film forming apparatus for forming a polymer film on a target substrate by a deposition polymerization, including: a stage provided inside a processing container in which the target substrate is accommodated, the target substrate being placed on the stage; a stage heater provided inside the stage and configured to heat the target substrate placed on the stage; a ceiling plate heater provided in a ceiling plate of the processing container to face the stage; and a controller configured to control a temperature of the target substrate in a first temperature unit by controlling a temperature of the stage heater on the first temperature unit, and to control the temperature of the target substrate on a temperature unit finer than the first temperature unit by a radiant heat radiated through the ceiling plate by controlling a temperature of the ceiling plate heater on a second temperature unit.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a view illustrating an example of a film forming apparatus according to a first embodiment of the present disclosure.

FIG. 2 is a view representing an example of the relationship between a wafer temperature and a deposition rate (D/R).

FIG. 3 is a view representing an example of a temperature distribution of a wafer.

FIG. 4 is a view illustrating an example of the relationship between a temperature of a ceiling plate heater and a wafer temperature.

FIG. 5 is a view illustrating an example of the relationship between a gap between a ceiling plate and a stage, and a wafer temperature.

FIG. 6 is a flowchart illustrating an example of a temperature control method of the first embodiment.

FIG. 7 is a view illustrating an example of a temperature measurement wafer.

FIG. 8 is a view illustrating an example of a film forming apparatus according to a second embodiment of the present disclosure.

FIG. 9 is a flowchart illustrating an example of a temperature control method of the second embodiment.

FIG. 10 is a view illustrating an example of divided ceiling plate heaters.

FIG. 11 is a view illustrating an example of divided sidewall heaters.

### DETAILED DESCRIPTION

Hereinafter, embodiments of a film forming apparatus and a temperature control method will be described in detail with reference to the drawings. The film forming apparatus and the temperature control method are not limited to the embodiments described later. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

In a vapor deposition polymerization, a film forming rate varies greatly depending on the temperature of a target substrate. Therefore, in order to control a film thickness of a polymer to be formed, it is required to control the temperature of the target substrate with higher accuracy. Therefore, the present disclosure provides a technique capable of controlling the temperature of the target substrate with high accuracy.

### First Embodiment

### Configuration of Film Forming Apparatus

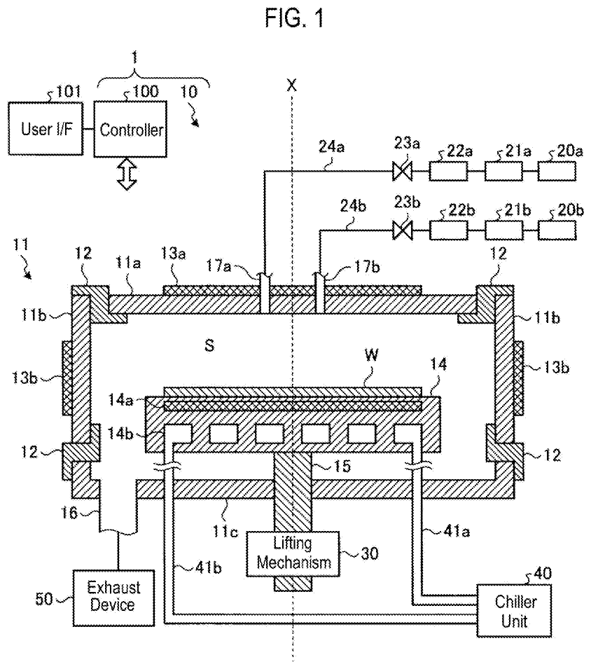

FIG. 1 is a view illustrating an example of a film forming apparatus 1 according to a first embodiment of the present disclosure. The film forming apparatus 1 according to the present embodiment forms a polymer film on a wafer W, which is an example of a target substrate, through the vapor deposition polymerization. The film forming apparatus 1 includes a body 10 and a controller 100. The body 10 includes a processing container 11 having a substantially cylindrical processing space S formed therein. The wafer W is accommodated in the processing container 11. The central axis of the substantially cylindrical processing space S formed in the processing container 11 will be defined as an axis X.

The processing container 11 includes a ceiling plate 11a, a sidewall 11b, and a bottom portion 11c. The ceiling plate 11a, the sidewall 11b, and the bottom portion 11c may be made from a corrosion-resistant metal such as aluminum, stainless steel, or nickel alloy. The ceiling plate 11a may have a flat plate shape, and the sidewall 11b may have a cylindrical shape. The ceiling plate 11a, the sidewall 11b, and the bottom portion 11c may be made of quartz or ceramic.

Thermal insulating members 12 are disposed between the ceiling plate 11a and the sidewall 11b, and between the sidewall 11b and the bottom portion 11c, respectively. This suppresses heat from being radiated between the ceiling plate 11a and the sidewall 11b, and between the sidewall 11b and the bottom portion 11c.

A stage 14 is provided inside the processing container 11 at a position facing the ceiling plate 11a. The wafer W is placed on the stage 14. The wafer W has a substantially disk-like shape, and is placed on the stage 14 such that the central axis of the wafer W coincides with the axis X. The stage 14 is supported by a support rod 15. A lifting mechanism 30 moves upward and downward the stage 14 by moving the support rod 15 in the vertical direction along the axis X. The lifting mechanism 30 changes a distance between the stage 14 and the ceiling plate 11a by moving upward and downward the stage 14. By changing the distance between the stage 14 and the ceiling plate 11a, a gap between the wafer W on the stage 14 and the ceiling plate 11a is changed. The upward/downward movement of the stage 14 by the lifting mechanism 30 is controlled by the controller 100.

A stage heater 14a for heating the wafer W placed on the stage 14 is provided inside the stage 14. In the stage 14, a flow path 14b through which a coolant such as Galden flows is formed. A Chiller unit 40 is connected to the flow path 14b via a pipe 41a and a pipe 41b. The coolant controlled to have a predetermined temperature is supplied from the Chiller unit 40 to the flow path 14b of the stage 14 through the pipe 41a. The coolant flowing through the flow path 14b returns to the Chiller unit 40 through the pipe 41b.

The temperature of the wafer W placed on the stage 14 is controlled by the heating performed by the stage heater 14a and the cooling caused by the coolant flowing through the flow path 14b. Hereinafter, the temperature of the wafer W, which is controlled by both the heating by the stage heater 14a and the cooling obtained by the coolant flowing through the flow path 14b, will be referred to as a stage temperature.

The stage heater 14a and the Chiller unit 40 are controlled by the controller 100. In the present embodiment, the temperature obtained by the stage heater 14a and the Chiller unit 40 is controlled with the resolution of a first temperature unit. That is to say, the stage temperature is controlled with the resolution of the first temperature unit. The first temperature unit may be a unit of 1 degree C.

A ceiling plate heater 13a is provided on the ceiling plate 11a. The ceiling plate heater 13a heats the ceiling plate 11a. The ceiling plate heater 13a is disposed on the ceiling plate 11a such that the central axis of the substantially disk-shaped outer shape thereof coincides with the axis X. When the ceiling plate 11a is heated by the ceiling plate heater 13a, heat is radiated from the ceiling plate 11a into the processing space S. The wafer W on the stage 14 is heated by the heat radiated from the ceiling plate 11a. The ceiling plate heater 13a is controlled by the controller 100.

A sidewall heater 13b is provided on a side surface of the sidewall 11b in the outside of the processing container 11. The sidewall heater 13b heats the sidewall 11b. As the sidewall 11b is heated by the sidewall heater 13b, heat is radiated into the processing space S from the sidewall 11b. The wafer W on the stage 14 is heated by the heat radiated from the sidewall 11b. The sidewall heater 13b is controlled by the controller 100. In the present embodiment, the temperatures of the ceiling plate heater 13a and the sidewall heater 13b are controlled with the resolution of a second temperature unit. The second temperature unit may be a unit of 1 degree C.

In addition, by moving upward and downward the stage 14 using the lifting mechanism 30, the gap between the wafer W on the stage 14 and the ceiling plate 11a is changed. In addition, by moving upward and downward the stage 14 using the lifting mechanism 30, a gap between the wafer W on the stage 14 and the sidewall 11b is also changed. This changes the amount of radiant heat applied to the wafer W from the ceiling plate 11a and the sidewall 11b.

A port (not illustrated) through which the wafer W is transferred is formed in the sidewall 11b. The port is opened and closed by a gate valve (not illustrated).

The ceiling plate 11a is provided with a gas supply port 17a and a gas supply port 17b through which gases are supplied into the processing space S of the processing container 11. A valve 23a, a flow rate controller 22a, a vaporizer 21a, and a raw material source 20a are connected to the gas supply port 17a via a pipe 24a. A valve 23b, a flow rate controller 22b, a vaporizer 21b, and a raw material source 20b are connected to the gas supply port 17b via a pipe 24b.

The raw material source 20a is a source of a raw material monomer such as isocyanate. The vaporizer 21a vaporizes the isocyanate remaining in a liquid state, which is supplied from the raw material source 20a. The flow rate controller 22a controls a flow rate of a gaseous isocyanate vaporized by the vaporizer 21a. The valve 23a controls the supply and cutoff of the gaseous isocyanate to the pipe 24a. The gaseous isocyanate supplied to the pipe 24a is supplied into the processing space S of the processing container 11 through the gas supply port 17a.

The raw material source 20b is a source of a raw material monomer such as amine. The vaporizer 21b vaporizes the amine remains in a liquid state, which is supplied from the raw material source 20b. The flow rate controller 22b controls a flow rate of the gaseous amine vaporized by the vaporizer 21b. The valve 23b controls the supply and cutoff of the gaseous amine to the pipe 24b. The gaseous amine supplied to the pipe 24b is supplied into the processing space S of the processing container 11 through the gas supply port 17b.

A polyurea film is formed on the wafer W by the polymerization reaction of the two types of raw material monomers supplied into the processing space S. The polyurea film is an example of the polymer film. The pipe 24a and the pipe 24b are heated to a predetermined temperature or higher (e.g., 180 degrees C. or higher) in order to maintain the vaporized states of the raw material monomers flowing therethrough. The vaporizers 21a and 21b, the flow rate controllers 22a and 22b, and the valves 23a and 23b are controlled by the controller 100.

An exhaust port 16 is formed in the bottom portion 11c. An exhaust device 50 such as a vacuum pump is connected to the exhaust port 16. By operating the exhaust device 50, the gas in the processing container 11 is exhausted through the exhaust port 16, so that the interior of the processing container 11 can be adjusted to have a predetermined pressure. The exhaust device 50 is controlled by the controller 100.

The controller 100 includes a memory, a processor, and the input/output interface (I/F). A user interface (I/F) 101 is connected to the controller 100 via the input/output interface. The user interface 101 includes an input device such as a keyboard, a touch panel or the like, and an output device such as a display or the like. The processor of the controller 100 controls each part of the body 10 via the input/output interface by reading and executing a program or recipe stored in the memory. In addition, the controller 100 receives an instruction imputed by the user via the user interface 101, and controls each part of the body 10 according to the instruction received from the user. In addition, the controller 100 outputs control results to the user interface 101.

### Dependence of Temperature on Deposition Rate

A mixed gas of the two types of raw material monomers causes a polymerization reaction at a predetermined temperature or lower to form a polymer. The lower the temperature, the more the polymer is produced. Therefore, the lower the temperature of the wafer W, the higher the deposition rate (D/R) of the polymer film laminated on the wafer W.

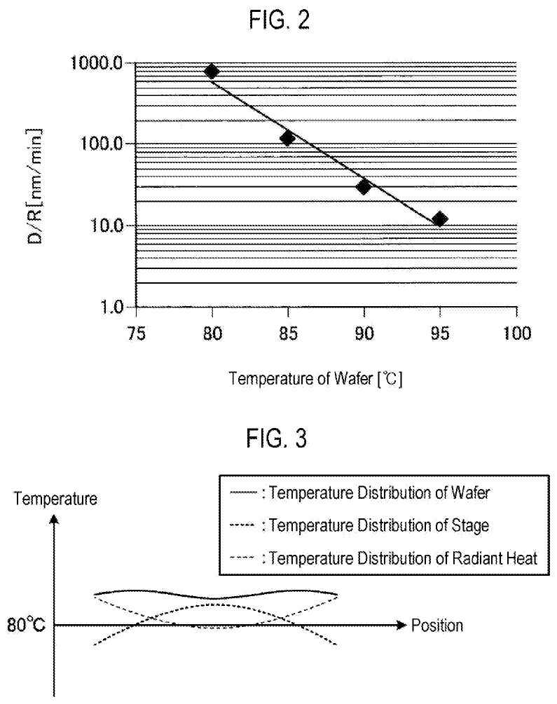

FIG. 2 is a view representing an example of the relationship between the temperature of the wafer W and the D/R. In the example of FIG. 2, a film thickness of the polymer changes by about 15% per 1 degree C. Therefore, for example, when the temperature of the wafer W is controlled using only the stage heater 14a and the Chiller unit 40 that are controlled with the resolution of 1 degree C. unit, a film thickness of the wafer W varies within a range of about 15%. When the variation in the film thickness of the wafer W is large, it is difficult to satisfy the requirement specification of the film thickness.

In order to reduce the variation in the film thickness of the wafer W, it may be considered to control the temperatures of the stage heater 14a and the Chiller unit 40 with the resolution finer than a unit of 1 degree C. Such a control increases the size of the film forming apparatus 1 or the cost of the film forming apparatus 1. This makes it difficult to enhance the resolution for controlling the temperatures of the stage heater 14a and the Chiller unit 40.

Therefore, in the present embodiment, the temperatures of the ceiling plate heater 13a and the sidewall heater 13b may be controlled with the resolution of a unit of 1 degree C. In addition, the gap between the ceiling plate 11a and the stage 14 may be controlled by the lifting mechanism 30 on a unit of 0.5 mm. This makes it possible to control the temperature of the wafer W with the resolution of a unit of 1 degree C. or less by the radiant heat radiated to the wafer W through the ceiling plate 11a. This enables the variation in the film thickness of the wafer W to be reduced.

### Temperature Distribution of Wafer

FIG. 3 is a view representing an example of a temperature distribution of the wafer W. When the temperature of the stage heater 14a is set to 80 degrees C., a temperature distribution on the upper surface of the stage 14 by the stage heater 14a may be obtained as indicated by a dotted line in FIG. 3.

Meanwhile, a temperature distribution obtained by the radiant heat radiated from the ceiling plate heater 13a and the sidewall heater 13b may be obtained as indicated by a broken line in FIG. 3. In this case, the temperature of each of the ceiling plate heater 13a and the sidewall heater 13b may be 120 degrees C., and the gap between the ceiling plate 11a and the stage 14 may be 20 mm.

For example, as indicated by the solid line in FIG. 3, a temperature distribution of the wafer W may be obtained by combining the temperature distribution of the stage heater 14a and the temperature distribution obtained by the radiant heat radiated from the ceiling plate heater 13a and the sidewall heater 13b. Therefore, even when the temperature of the stage heater 14a is fixed, it is possible to change the temperature of the wafer W by adjusting the radiant heat radiated from the ceiling plate heater 13a and the sidewall heater 13b.

### Relationship between Temperature of Ceiling Plate and Temperature of Wafer

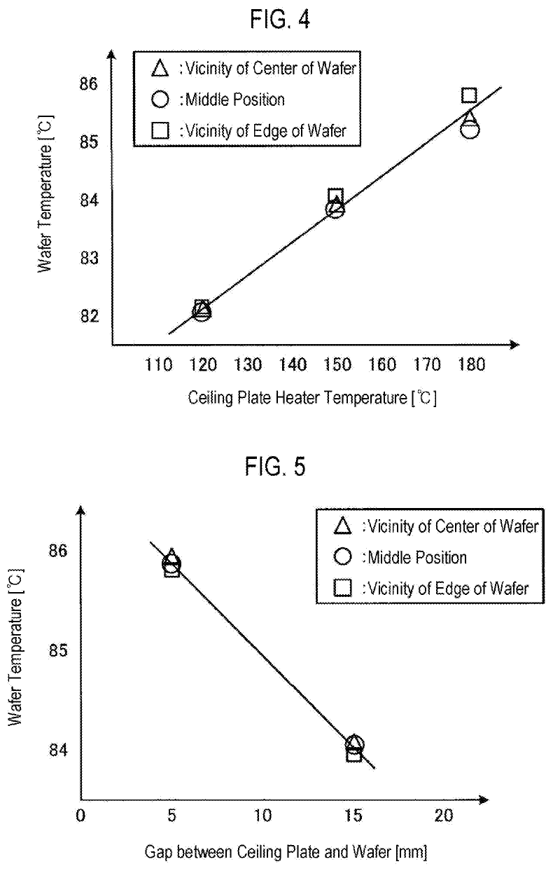

FIG. 4 is a view illustrating an example of the relationship between the temperature of the ceiling plate heater 13a and the temperature of the wafer W. In the test represented in FIG. 4, the stage temperature by the stage heater 14a and the Chiller unit 40 is set to 80 degrees C., the temperature of the sidewall heater 13b is set to 120 degrees C., and the gap between the ceiling plate 11a and the stage 14 is set to 20 mm.

For example, as represented in FIG. 4, as the temperature of the ceiling plate heater 13a increases, the temperature of the wafer W is also increased by the radiant heat through the ceiling plate 11a. Referring to FIG. 4, it can be seen that this tendency is the same at any of the vicinity of the center, the vicinity of the edge, and the middle portion in the wafer W.

Here, even if the temperature of the ceiling plate heater 13a is increased by 60 degrees C., the temperature of the wafer W is increased only by about 6 degrees C. That is to say, the change in temperature of the wafer W is about 1/10 of the change in temperature of the ceiling plate heater 13a. Therefore, by controlling the temperature of the ceiling plate heater 13a with the resolution of a unit of 1 degree C., it is possible to control the temperature of the wafer W with the resolution of a unit of 1 degree C. or less (specifically, for example, the resolution of a unit of about 0.1 degrees C.). This may reduce a variation in film thickness of the wafer W in a range of, for example, about 1.5%.

Even by the sidewall heater 13b, the radiant heat is radiated from the sidewall 11b to the wafer W. Therefore, it is considered that, by controlling the temperature of the sidewall heater 13b on a unit of 1 degree C., it is possible to control the temperature of the wafer W with the resolution of a unit of 1 degree C. or less. In addition, by adjusting a ratio of the temperature of the ceiling plate heater 13a to the temperature of the sidewall heater 13b, it is possible to make the temperature in the vicinity of the wafer W higher than that in the vicinity of the edge thereof, or to make the temperature in the vicinity of the center of the wafer W lower than that in the vicinity of the edge thereof. Therefore, it is possible to control the temperature distribution of the wafer W in the radial direction of the wafer W centered at the axis X by adjusting the ratio of the temperature of the ceiling plate heater 13a to the temperature of the sidewall heater 13b.

### Relationship between Gap between Ceiling Plate and Stage and Temperature of Wafer

In a case where a silicon film, a dielectric film, a metal film, or the like is formed through a chemical vapor deposition (CVD) or an atomic layer deposition (ALD), the film formation is controlled by a surface adsorption reaction. Therefore, the temperature of the stage 14 on which the wafer W is placed becomes dominant However, in the polymerization reaction using two types of monomers as in the present embodiment, not only the temperature of the stage 14 but also the temperature of the processing space S affects the reaction.

The present inventors have found that radiant heat in the infrared region (100 μm to 1,000 μm), in which the radiant heat has a long wavelength and is hard to scatter, is suitable for the monomer polymerization reaction. In addition, the present inventors have found that it is possible to control the radiation distance of infrared rays by controlling the distance between the ceiling plate 11a and the stage 14 inside the processing container 11, thus controlling the uniformity of film formation on the wafer W. Such control is suitable for the polymerization reaction.

FIG. 5 is a view illustrating an example of the relationship between the gap between the ceiling plate 11a and the stage 14 and the temperature of the wafer W. In the test represented in FIG. 5, the stage temperature by the stage heater 14a and the Chiller unit 40 is set to 80 degrees C., and the temperature of each of the ceiling plate heater 13a and the sidewall heater 13b is set to 120 degrees C.

For example, as represented in FIG. 5, as the gap between the ceiling plate 11a and the stage 14 increases, the amount of radiant heat radiated from the ceiling plate 11a and the sidewall 11b to the wafer W is decreased. Thus, the temperature of the wafer W is decreased. Meanwhile, as the gap between the ceiling plate 11a and the stage 14 decreases, the amount of radiant heat radiated from the ceiling plate 11a and the sidewall 11b toward the wafer W is increased. Thus, the temperature of the wafer W is increased.

Here, referring to FIG. 5, when the gap between the ceiling plate 11a and the stage 14 is increased by 10 mm, the temperature of the wafer W is decreased by about 2 degrees C. That is to say, by changing the gap between the ceiling plate 11a and the stage 14 by 1 mm, it is possible to change the temperature of the wafer W by about 0.2 degrees C. In the lifting mechanism 30 of the present embodiment, it is possible to move upward and downward the stage 14 with the resolution of a unit of 0.5 mm. Therefore, by controlling the gap between the ceiling plate 11a and the stage 14, the temperature of the wafer W can be adjusted on a unit of about 0.1 degrees C. In addition, it is also possible to reduce the variation in the film thickness of the wafer W in a range of, for example, about 1.5%, by controlling the gap between the ceiling plate 11a and the stage 14.

### Temperature Control Method

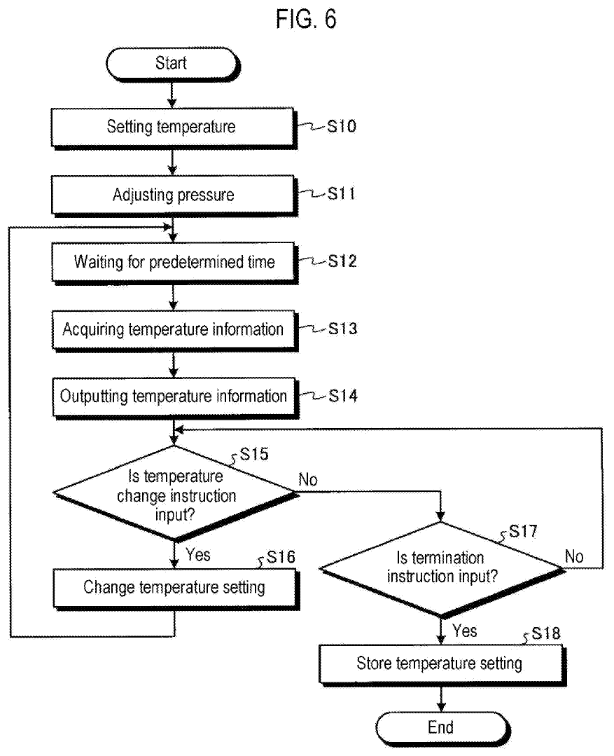

FIG. 6 is a flowchart illustrating an example of a temperature control method of the first embodiment. The temperature control method exemplified in FIG. 6 is implemented by controlling each part of the body 10 by the controller 100.

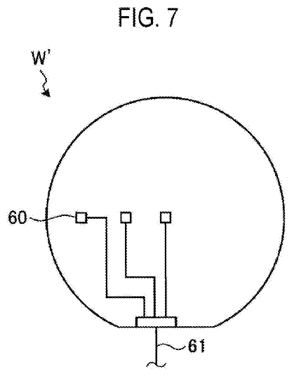

In the temperature control method as illustrated in FIG. 6, for example, a temperature measurement wafer W′ illustrated in FIG. 7 is placed on the stage 14 in advance. FIG. 7 is a view illustrating an example of the temperature measurement wafer W′. The temperature measurement wafer W′ includes one or more temperature sensors 60. In the example of FIG. 7, the temperature sensors 60 are provided at positions in the vicinity of the center of the wafer W, in the vicinity of the edge, and in the vicinity of the middle between the center and the edge, respectively. The temperature sensors 60 are connected to the controller 100 via a cable 61, and outputs measured temperature information to the controller 100, respectively. The temperature sensors 60 may be thermocouples. The temperature information measured by each temperature sensor 60 may be outputted to the controller 100 through a wireless communication.

Returning back to FIG. 6, the description will be continued. First, the controller 100 sets the temperature of each heater of the body 10 (S10). In step S10, the controller 100 controls the stage heater 14a and the Chiller unit 40 with the resolution of a unit of 1 degree C. such that the stage temperature by the stage heater 14a and the Chiller unit 40 becomes an initial value (e.g., 80 degrees C.). In addition, the controller 100 controls the ceiling plate heater 13a and the sidewall heater 13b with the resolution of a unit of 1 degree C. such that the temperatures of the ceiling plate heater 13a and the sidewall heater 13b become initial values (e.g., 180 degrees C.). Moreover, the controller 100 controls the lifting mechanism 30 such that the gap between the ceiling plate 11a and the stage 14 becomes an initial value (e.g., 20 mm).

Subsequently, the controller 100 controls the vaporizers 21a and 21b, the flow rate controllers 22a and 22b, and the valves 23a and 23b to supply gases of the two types of raw material monomers into the processing container 11 at predetermined flow rates. The controller 100 adjusts an internal pressure of the processing container 11 by operating the exhaust device 50 (S11). Then, the controller 100 waits for a predetermined period of time until an internal temperature and the internal pressure of the processing container 11 are stabilized (S12).

Subsequently, the controller 100 acquires information on temperatures measured by the temperature sensors 60 of the temperature measurement wafer W′ placed on the stage 14 (S13). The controller 100 outputs the acquired temperature information to the user interface 101 (S14).

Based on the temperature of the wafer W displayed on the user interface 101, the user of the film forming apparatus 1 determines the temperature setting of the ceiling plate heater 13a and the sidewall heater 13b to set the temperature of the wafer W to a target temperature (e.g., 80 degrees C.). When the temperatures measured by the temperature sensors 60 differ from each other, the average value of the temperatures measured by the temperature sensors 60 is used. Then, the user inputs a temperature change instruction including the determined temperature setting to the controller 100 via the user interface 101. The temperature change instruction may include the value of the gap between the ceiling plate 11a and the stage 14.

The controller 100 determines whether or not the temperature change instruction is inputted via the user interface 101 (S15). If it is determined that the temperature change instruction is inputted (S15: YES), the controller 100 changes the temperature setting of the ceiling plate heater 13a and the sidewall heater 13b with the resolution in a unit of 1 degree C. in response to the temperature change instruction (S16). Thereby, the temperature of the wafer W is controlled with the resolution of a unit of 1 degree C. or less (e.g., 0.1 degrees C.) by the radiant heat of the ceiling plate 11a and the sidewall 11b.

In addition, when the temperature change instruction includes the value of the gap between the ceiling plate 11a and the stage 14, the controller 100 controls the lifting mechanism 30 in response to the temperature change instruction to change the gap between the ceiling plate 11a and the stage 14. Thereby, the amount of radiant heat from the ceiling plate 11a and the sidewall 11b is changed, so that the temperature of the wafer W is controlled with the resolution of a unit of 1 degree C. or less (e.g., 0.1 degrees C.). The controller 100 executes the processing as illustrated in step S12 again.

Meanwhile, if it is determined that the temperature change instruction is not inputted (S15: NO), the controller 100 determines whether or not a termination instruction is inputted via the user interface 101 (S17). If it is determined that the termination instruction is not inputted (S17: NO), the controller 100 executes the processing as illustrated in step S15 again.

Meanwhile, If it is determined that the termination instruction is inputted (S17), the controller 100 stores values of the temperature settings of the ceiling plate heater 13a, the sidewall heater 13b, the stage heater 14a, and the Chiller unit 40 in the memory (S18). The set value of the gap between the ceiling plate 11a and the stage 14 is also stored in the memory. These set values stored in the memory are used when performing the film forming process on the wafer W. The controller 100 terminates the temperature control method as illustrated by the flowchart of FIG. 6.

The first embodiment has been described above. The film forming apparatus 1 of the present embodiment is an apparatus for forming the polymer film on the wafer W through the vapor deposition polymerization, and includes the stage 14, the stage heater 14a, the ceiling plate heater 13a, and the controller 100. The stage 14 is provided inside the processing container 11 that accommodates the wafer W, and the wafer W is placed on the stage 14. The stage heater 14a is provided inside the stage 14 to heat the wafer W placed on the stage 14. The ceiling plate heater 13a is provided on the ceiling plate 11a of the processing container 11 that faces the stage 14. The controller 100 controls the temperatures of the stage heater 14a and the ceiling plate heater 13a. Further, the controller 100 controls the temperature of the wafer W on a first temperature unit by controlling the temperature of the stage heater 14a on the first temperature unit. Further, the controller 100 controls the temperature of the wafer W on a temperature unit finer than the first temperature unit by the radiant heat radiated through the ceiling plate 11a by controlling the temperature of the ceiling plate heater 13a on a second temperature unit. This enables the film forming apparatus 1 to control the temperature of the wafer W with high accuracy.

In addition, the film forming apparatus 1 according to the above-described embodiment further includes the sidewall heater 13b provided on the sidewall 11b of the processing container 11. The controller 100 controls the temperature of the wafer W on a temperature unit finer than the first temperature unit by the radiant heat radiated through the sidewall 11b by controlling the temperature of the sidewall heater 13b on the second temperature unit. This enables the film forming apparatus 1 to control the temperature of the wafer W with high accuracy.

In addition, the film forming apparatus 1 of the above-described embodiment further includes the lifting mechanism 30 that changes the distance between the stage 14 and the ceiling plate 11a by moving upward and downward the stage 14. The controller 100 changes the amount of radiant heat radiated from the ceiling plate 11a and the sidewall 11b toward the wafer W by controlling the lifting mechanism 30 to change the distance between the stage 14 and the ceiling plate 11a. This enables the film forming apparatus 1 to control the temperature of the wafer W with high accuracy.

In the above-described embodiment, each of the first temperature unit and the second temperature unit is a unit of 1 degree C., and the temperature unit finer than the first temperature unit is a unit of 0.1 degrees C. or less. This enables the film forming apparatus 1 to control the temperature of the wafer W with high accuracy on a temperature unit of 0.1 degrees C. or less.

### Second Embodiment

In the film forming apparatus 1 of the first embodiment, the temperature setting of each heater during the film forming process is determined using the temperature measurement wafer W′. In contrast, in the film forming apparatus 1 of the second embodiment, the temperature of the wafer W is measured during the film forming process of the wafer W, and the temperature of each heater or the like is controlled such that the temperature wafer W becomes a predetermined temperature.

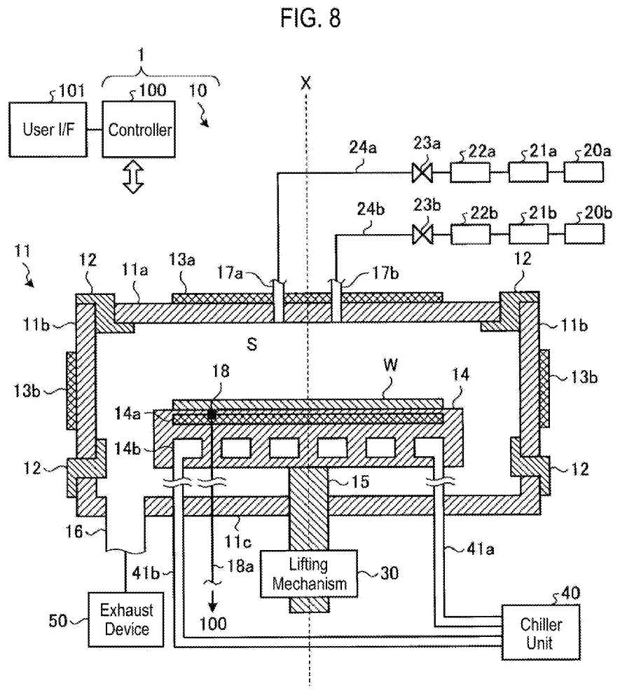

FIG. 8 is a view illustrating an example of the film forming apparatus 1 according to the second embodiment of the present disclosure. Components in FIG. 8 denoted by the same reference numerals as components in FIG. 1 have functions equal to or similar to those of the components shown in FIG. 1 except for matters to be described below, and therefore, descriptions thereof will be omitted.

A temperature sensor 18 is provided in the stage 14. The temperature sensor 18 measures a temperature of a surface of the wafer W, which brings into contact with the stage 14, as the temperature of the wafer W. The temperature sensor 18 may be a thermocouple or an optical fiber-type thermometer. A plurality of temperature sensors 18 may be provided in the stage 14. Information on the temperature of the wafer W measured by the temperature sensor 18 is outputted to the controller 100 via a cable 18a.

Based on the temperature of the wafer W measured by the temperature sensor 18, the controller 100 may change the temperature setting of the ceiling plate heater 13a and the sidewall heater 13b on a unit of 1 degree C. during the film forming process such that a difference between the temperature of the wafer W and a target temperature (e.g., 80 degrees C.) is reduced. In addition, based on the temperature information outputted from the temperature sensor 18, the controller 100 may change the gap between the ceiling plate 11a and the stage 14 on a unit of 0.5 mm during the film forming process such that the difference between the temperature of the wafer W and the target temperature is reduced.

### Temperature Control Method

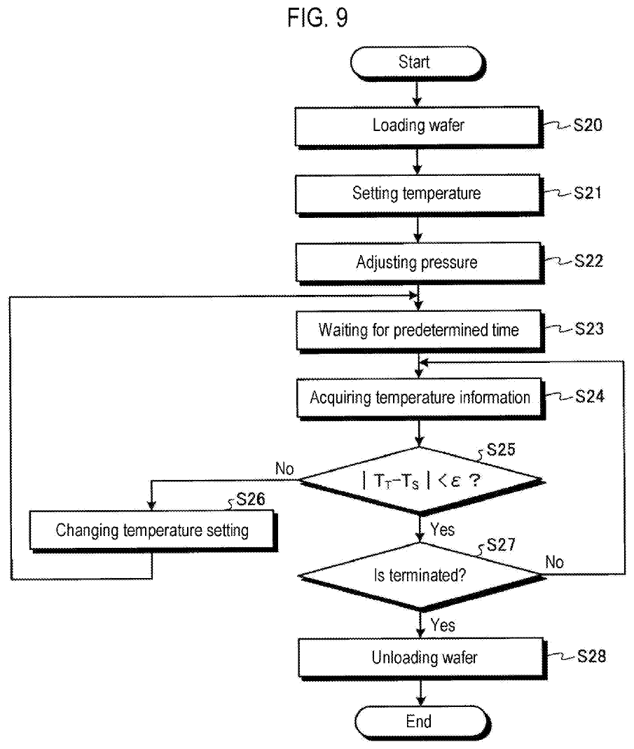

FIG. 9 is a flowchart illustrating an example of the temperature control method of the second embodiment. The temperature control method exemplified in FIG. 9 is implemented by controlling each part of the body 10 by the controller 100.

First, a gate valve (not illustrated) is opened and the wafer W is loaded into the processing container 11 by a transfer mechanism (not illustrated). The wafer W is placed on the stage 14 (S20). Then, the transfer mechanism is withdrawn from the processing container 11 and the gate valve is closed.

Subsequently, the controller 100 performs the temperature setting of each heater of the body 10 (S21). In step S21, the controller 100 controls the stage heater 14a and the Chiller unit 40 on a first temperature unit such that the stage temperature by the stage heater 14a and the Chiller unit 40 becomes an initial value (e.g., 80 degrees C.). The first temperature unit may be a unit of 1 degree C. In addition, the controller 100 controls the ceiling plate heater 13a and the sidewall heater 13b such that the temperatures of the ceiling plate heater 13a and the sidewall heater 13b become initial values (e.g., 180 degrees C.). In addition, the controller 100 controls the lifting mechanism 30 such that the gap between the ceiling plate 11a and the stage 14 becomes an initial value (e.g., 20 mm). Each initial value used in step S21 may be the set value determined in the first embodiment. Step S21 is an example of a first control step.

Subsequently, the controller 100 controls the vaporizers 21a and 21b, the flow rate controllers 22a and 22b, and the valves 23a and 23b to supply gases of the two types of raw material monomers into the processing container 11 at predetermined flow rates. The controller 100 adjusts an internal pressure of the processing container 11 by operating the exhaust device 50 (S22). Then, the controller 100 waits for a predetermined period of time until an internal temperature and the internal pressure of the processing container 11 are stabilized (S23).

Subsequently, the controller 100 acquires information on a temperature T_{S} of the wafer W measured by the temperature sensor 18 (S24). Step S24 is an example of an acquisition step. Then, the controller 100 determines whether or not a difference between the temperature T_{S} of the wafer W and a target temperature T_{T} (e.g., 80 degrees C.) is less than a predetermined value (S25).

If it is determined that the difference between the temperature T_{S} of the wafer W and the target temperature T_{T} is equal to or greater than the predetermined value ε (S25: NO), the controller 100 determines the temperature setting of the ceiling plate heater 13a and the sidewall heater 13b to set the temperature T_{S} of the wafer W to the target temperature T_{T} based on the difference between the temperature T_{S} and the target temperature T_{T}. Then, the controller 100 changes the temperature setting of the ceiling plate heater 13a and the sidewall heater 13b on a second temperature unit such that the temperature setting thus determined is achieved (S26). The second temperature unit may be a unit of 1 degree C. Step S26 is an example of a second control step. The controller 100 executes the processing as illustrated in step S23 again.

If it is determined that the temperature T_{S} of the wafer W is lower than the target temperature T_{T} by the predetermined value ε or more, the controller 100 may change the temperature setting of the ceiling plate heater 13a and the sidewall heater 13b so as to increase the temperature setting of the ceiling plate heater 13a and the sidewall heater 13b by a predetermined temperature ΔT. In addition, if it is determined that the temperature T_{S} of the wafer W is higher than the target temperature T_{T} by the predetermined value ε or more, the controller 100 may change the temperature setting of the ceiling plate heater 13a and the sidewall heater 13b so as to lower the temperature setting of the ceiling plate heater 13a and the sidewall heater 13b by the predetermined temperature ΔT. The predetermined temperature ΔT may be 1 degree C.

In step S26, the controller 100 may change the gap between the ceiling plate 11a and the stage 14 by controlling the lifting mechanism 30 such that the temperature T_{S} of the wafer W approaches the target temperature T_{T}. In this case, when the temperature T_{S} of the wafer W is lower than the target temperature T_{T} by the predetermined value ε or more, the controller 100 may control the lifting mechanism 30 such that the gap between the ceiling plate 11a and the stage 14 is shortened by a predetermined length ΔL. In addition, when the temperature T_{S} of the wafer W is higher than the target temperature T_{T} by the predetermined value ε or more, the controller 100 may control the lifting mechanism 30 such that the gap between the ceiling plate 11a and the stage 14 is increased by the predetermined length ΔL. The predetermined length ΔL may be 0.5 mm.

Meanwhile, if it is determined that the difference between the temperature T_{S} of the wafer W and the target temperature T_{T} is less than the predetermined value ε (S25: YES), the controller 100 determines whether or not the film forming process for the wafer W has been completed (S27). For example, when a film forming time reaches a predetermined time, the controller 100 determines that the film forming process is completed.

If it is determined that the film forming process on the wafer W has not been terminated (S27: NO), the controller 100 executes the processing represented in step S24 again. Meanwhile, if it is determined that the film forming process on the wafer W has been terminated (S27: YES), the controller 100 controls the vaporizers 21a and 21b, the flow rate controllers 22a and 22b, and the valves 23a and 23b to stop the supply of the gases of the raw material monomers. In addition, the controller 100 stops the operation of the exhaust device 50. Then, the gate valve (not illustrated) is opened, and the wafer W is unloaded from the interior of the processing container 11 by the transfer mechanism (not illustrated) (S28). In the manner, the temperature control method as illustrated by the flowchart of FIG. 9 is terminated.

The second embodiment has been described above. In the second embodiment, the controller 100 executes the first control step of controlling the temperature of the stage heater 14a on the first temperature unit. In addition, the controller 100 executes the acquisition step of acquiring the temperature of the wafer W measured by the temperature sensor 18. In addition, the controller 100 executes the second control step of controlling the temperature of the ceiling plate heater 13a on the second temperature unit such that the difference between the measured temperature of the wafer W and the target temperature is equal to or lower than a predetermined value, and controlling the temperature of the wafer W on a temperature unit finer than the first temperature unit by the radiant heat radiated through the ceiling plate 11a. This enables the film forming apparatus 1 to control the temperature of the wafer W with high accuracy.

### Others

The technique disclosed in the present application is not limited to the above-described embodiments, and various modifications are possible within the scope of the gist thereof.

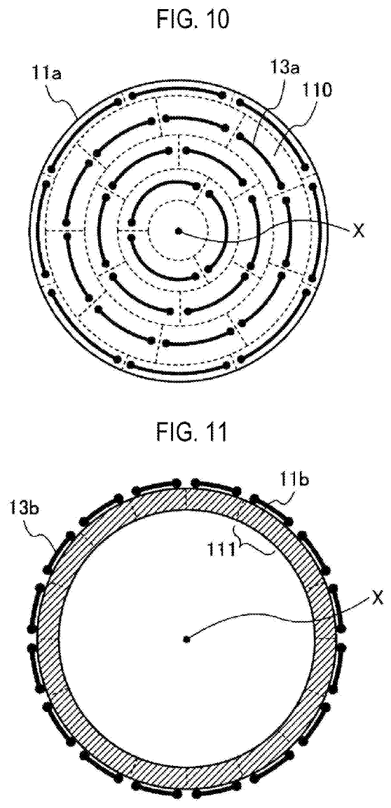

For example, in each of the above-described embodiments, the ceiling plate heater 13a may be divided into a plurality of heaters in the radial direction and the circumferential direction of a circle centered at the axis X, as illustrated in FIG. 10. Each of the divided ceiling plate heaters 13a heats the ceiling plate 11a in an area 110 in which the respective ceiling plate heater 13a is disposed, so that heat corresponding to the temperature of the ceiling plate 11a in the area 110 is radiated toward the wafer W. Based on the temperature distribution of the wafer W, the controller 100 independently controls the temperatures of the divided ceiling plate heaters 13a on the second temperature unit. The second temperature unit may be a unit of 1 degree C. This makes it possible to control the temperature distribution of the wafer W in the circumferential direction and the radial direction of the circle centered at the axis X.

The ceiling plate heater 13a may be divided into a plurality of heaters in either of the radial direction or the circumferential direction of a circle centered at the axis X. In addition, the stage heater 14a may be divided into a plurality of heaters in at least one of the radial direction and the circumferential direction of a circle centered at the axis X, similarly to the ceiling plate 11a as illustrated in FIG. 10.

In each of the above-described embodiments, the sidewall heater 13b may be divided into a plurality of heaters in the circumferential direction of a circle centered at the axis X, as illustrated in FIG. 11. Each of the divided sidewall heaters 13b heats the sidewall 11b in an area 111 in which the respective sidewall heater 13b is disposed, so that heat corresponding to the temperature of the sidewall 11b in the area 111 is radiated toward the wafer W. Based on the temperature distribution of the wafer W, the controller 100 independently controls the temperatures of the divided sidewall heaters 13b on the second temperature unit. The second temperature unit may be a unit of 1 degree C. This makes it possible to control the temperature distribution of the wafer W in the circumferential direction of the circle centered at the axis X.

In the film forming apparatus 1 of each of the above-mentioned embodiments, although the ceiling plate 11a is formed in a flat plate shape, the present disclosure is not limited thereto. For example, the ceiling plate 11a may have a shape in which the distance between the ceiling plate 11a and the stage 14 increases as a distance from the axis X increases (e.g., a dome shape or a cone shape).

In the film forming apparatus 1 of each of the above embodiments, when the amount of radiant heat radiated from the sidewall 11b toward the wafer W is large (e.g., when a change in temperature of the wafer W is great relative to that of the sidewall heater 13b), a shielding member may be provided between the sidewall 11b and the wafer W. This makes it possible to reduce the temperature change of the wafer W relative to that of the sidewall heater 13b, thus controlling the temperature of the wafer W with higher accuracy.

In the film forming apparatus 1 of each of the above embodiments, the temperatures of the ceiling plate heater 13a, the sidewall heater 13b, and the stage heater 14a are controlled with the resolution of a unit of 1 degree C., but the present disclosure is not limited thereto. For example, the temperature control units of the ceiling plate heater 13a and the sidewall heater 13b may be different from the temperature control unit of the stage heater 14a. Specifically, when the temperatures of the ceiling plate heater 13a and the sidewall heater 13b are controlled with the resolution of a unit of 1 degree C., the temperature of the stage heater 14a may be controlled with the resolution of a unit of 2 degrees C. or more.

According to various aspects and embodiments of the present disclosure, it is possible to control the temperature of a target substrate with high accuracy.

It should be noted that the embodiments disclosed herein are exemplary in all respects and are not restrictive. Indeed, the embodiments described above may be implemented in various forms. The above-described embodiments may be omitted, replaced or modified in various forms without departing from the scope and spirit of the appended claims.

What is claimed is:

1. A film forming apparatus for forming a polymer film on a target substrate by a deposition polymerization, comprising:
a stage provided inside a processing container in which the target substrate is accommodated, the target substrate being placed on the stage;
a stage heater provided inside the stage and configured to heat the target substrate placed on the stage;
a ceiling plate heater provided in a ceiling plate of the processing container to face the stage; and
a controller configured to control a temperature of the target substrate in a first temperature unit by controlling a temperature of the stage heater on the first temperature unit, and to control the temperature of the target substrate on a temperature unit finer than the first temperature unit by a radiant heat radiated through the ceiling plate by controlling a temperature of the ceiling plate heater on a second temperature unit.

2. The film forming apparatus of claim 1, wherein the target substrate is formed in a substantially disk shape,
the ceiling plate heater is divided into a plurality of heaters in at least one of a radial direction and a circumferential direction of a circle centered at a central axis of the target substrate, and
the controller is configured to independently control a temperature of each of the plurality of divided ceiling plate heaters on the second temperature unit.

3. The film forming apparatus of claim 1, further comprising:
a sidewall heater provided on a sidewall of the processing container,
wherein the controller is configured to control the temperature of the target substrate in the temperature unit finer than the first temperature unit by a radiant heat radiated through the sidewall by controlling a temperature of the sidewall heater on the second temperature unit.

4. The film forming apparatus of claim 3, wherein the target substrate is formed in a substantially disk-like shape,
the sidewall heater is divided into a plurality of heaters in a circumferential direction of a circle centered at the central axis of the target substrate, and
the controller is configured to independently control a temperature of each of the plurality of divided sidewall heaters on the second temperature unit.

5. The film-forming apparatus of claim 3, further comprising:
a lifting mechanism configured to change a distance between the stage and the ceiling plate by moving upward and downward the stage,
wherein the controller changes an amount of a radiant heat radiated from the ceiling plate and the sidewall toward the target substrate by controlling the lifting mechanism to change the distance between the stage and the ceiling plate.

6. The film forming apparatus of claim 1, whereon the first temperature unit and the second temperature unit are a unit of 1 degree C., respectively, and
the temperature unit finer than the first temperature unit is a temperature unit of 0.1 degrees C. or less.

7. A film forming method of forming a polymer film on a target substrate through a deposition polymerization, in a film forming apparatus,
wherein the film forming apparatus comprises:
a stage provided inside a processing container in which the target substrate is accommodated, the target substrate being placed on the stage;
a stage heater provided inside the stage and configured to heat the target substrate placed on the stage;
a sensor provided inside the stage and configured to measure a temperature of the target substrate;
a ceiling plate heater provided on a ceiling plate of the processing container to face the stage; and
a controller configured to control temperatures of the stage heater and the ceiling plate heater, the method comprising:
controlling, by the controller, the temperature of the stage heater on a first temperature unit;
acquiring, by the controller, the temperature of the target substrate, which is measured by the sensor; and
controlling, by the controller, the temperature of the target substrate on a temperature unit finer than the first temperature unit by a radiant heat radiated through the ceiling plate by controlling the temperature of the ceiling plate heater on a second temperature unit such that a difference between the measured temperature of the target substrate and a target temperature is equal to or lower than a predetermined value.
